(19) United States
(12) Patent Application Publication
(10) Pub. No.: US 2022/0345479 A1
(43) Pub. Date: Oct. 27, 2022

(54) SYSTEM AND METHOD FOR FULLY AUTONOMOUS USER BEHAVIOR BASED SECURITY TESTING

(71) Applicant: Citrix Systems, Inc., Fort Lauderdale, FL (US)

(72) Inventors: Dimitrios Markonis, Athens (GR); Konstantinos Katrinis, Athens (GR); Aikaterini Kalou, Patras (GR)

(21) Appl. No.: 17/315,644

(22) Filed: May 10, 2021

Related U.S. Application Data
(63) Continuation of application No. PCT/GR2021/000021, filed on Apr. 22, 2021.

(51) Int. Cl. H04L 29/06; G06N 20/00; G06N 5/04

(52) U.S. Cl. CPC H04L 63/1433; G06N 20/00; G06N 5/04

(57) ABSTRACT

A system and method for identifying vulnerabilities in a security information and event management (SIEM) system. A method includes: initializing a security testing agent with a goal and a reinforcement learning model, wherein the model defines states indicative of progress towards the goal, a set of actions that can be taken by a legitimate user within a target environment, and reward values associated with taking a specified action in a specified state; and learning a policy to achieve the goal within the target environment, wherein learning: selects and takes a target action from the set of actions for a current state; monitors for an alert triggered in response to the target action being taken; receives a reward value associated with the target action and current state; calculates updated reward value in the model; and in response to the process not being terminated, repeats the process for a next state.

### BACKGROUND OF THE DISCLOSURE

Security information and event management (SIEM) software works by collecting log and event data generated by an organization's information technology (IT) infrastructure (e.g., applications, security devices and host systems) and aggregates the data to detect threats. SIEM software gives enterprise security professionals both insight into and a track record of the activities within their information IT infrastructure. SIEM combines (1) security event management that analyzes log and event data in real time to provide threat monitoring, event correlation and incident response with (2) security information management that collects, analyzes and reports on log data.

One approach for testing the efficacy of a SIEM system is to utilize penetration testing. In its most conventional form, penetration testing assumes a human made model of the system-under-attack, as well as a script comprising a pre-defined sequence of test and exploitation steps. When utilized with a SIEM solution, common practice is to use an automated process to test the SIEM system against expected versus incurred security alerts.

### BRIEF DESCRIPTION OF THE DISCLOSURE

Aspects of this disclosure include a system and method for identifying vulnerabilities in a security information and event management (SIEM) system.

A first aspect of the disclosure provides a method for identifying vulnerabilities in a security information and event management (SIEM) system. The process includes initializing a security testing agent (STA) with a test scenario goal and a reinforcement learning model, wherein the model defines a set of states indicative of progress towards the goal, a set of actions that can be taken by a legitimate user within a target environment, and a set of reward values associated with taking a specified action in a specified state. The process further includes learning a policy to achieve the goal within the target environment, wherein the learning includes a process that: selects and takes a target action from the set of actions for a current state; monitors for an alert triggered in response to the target action being taken within the target environment; receives a reward value associated with the target action and current state; calculates and saves an updated reward value in the model; and in response to the process not being terminated, repeats the process for a next state.

A second aspect of the disclosure provides a system that includes a memory; and a processor coupled to the memory and configured to identify vulnerabilities associated with user actions in a security information and event management (SIEM) system. Identifying vulnerabilities includes initializing a security testing agent (STA) with a test scenario goal and a reinforcement learning model, wherein the model defines a set of states indicative of progress towards the goal, a set of actions that can be taken by a legitimate user within a target environment, and a set of reward values associated with taking a specified action in a specified state. The system further includes learning a policy to achieve the goal within the target environment, wherein the learning includes a process that: selects and takes a target action from the set of actions for a current state; monitors for an alert triggered in response to the target action being taken within the target environment; receives a reward value associated with the target action and current state; calculates and saves an updated reward value in the model; and in response to the process not being terminated, repeats the process for a next state.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 depicts security testing agent interfacing with an IT infrastructure protected by a SIEM system, in accordance with an illustrative embodiment.

FIG. 2 depicts an illustrative Q matrix in accordance with an illustrative embodiment.

FIG. 3 depicts a flow chart for a policy learning process in accordance with an illustrative embodiment.

FIG. 4 depicts an illustrative execution graph of a trained security testing agent (STA) using a learned policy, in accordance with an illustrative embodiment.

FIG. 5 depicts a network infrastructure, in accordance with an illustrative embodiment.

FIG. 6 depicts a computing system, in accordance with an illustrative embodiment.

The drawings are intended to depict only typical aspects of the disclosure, and therefore should not be considered as limiting the scope of the disclosure.

### DETAILED DESCRIPTION OF THE DISCLOSURE

Embodiments of the disclosure provide technical solutions for identifying vulnerabilities in a security information and event management (SIEM) system. As noted, one approach for testing a SIEM system is to utilize penetration testing. However, such an approach is subject to various shortcomings as penetration security testing relies heavily on human labor to draft automated tests. Accordingly, the accuracy and span of coverage scales with the attack surface that the SIEM system is missioned to protect against. Moreover, in unified engineering environments, where it is not uncommon for the human developing the SIEM system to also be the one developing automated security tests, test bias against common cases can result.

Furthermore, as probabilistic approaches based on machine learning are increasingly being employed to indicate security risks or alerts of potential attacks, it becomes increasingly difficult to rely on human intuition to prepare penetration test processes. The difficulty is increased as the underlying machine learning models gets continuously retrained. Accordingly, a pre-scripted agent behavior that led to discovering a security hole on one day is not guaranteed to succeed on a later day, due to the shifting state of a machine learning model.

The present approach provides a technical solution to the above technical problem by using an autonomous learning agent, referred to herein as a security testing agent (STA), that continuously learns attack strategies and, e.g., uses informed trial-and-error (or action-reward states) to test a given system against states that can pose security risks. Successful attacks can then be reported for attention and/or fixing. In one embodiment, reinforcement learning is utilized to identify vulnerabilities in a SIEM system involving end-user behavior telemetry. Namely, this approach incorporates attack vectors stemming from potential behaviors of a “legitimate” user, such as excessive file downloading, excessive deletion of files, access to content that is off-policy, data exfiltration, unauthorized use of an information technology service, unauthorized use of data, malicious acts targeting availability or reliability of an IT service, etc.

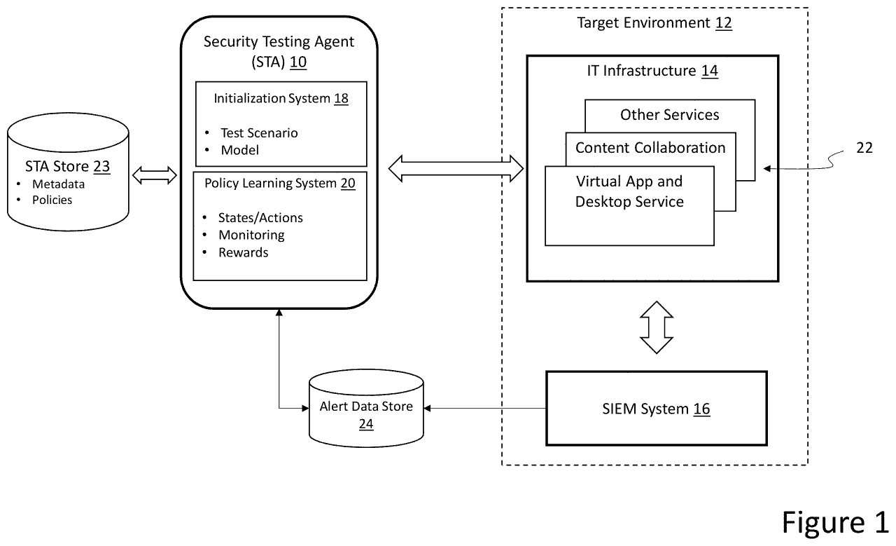

FIG. 1 depicts an illustrative STA 10 configured to interface with a target environment 12, which includes an IT infrastructure 14 and an SIEM system 16. SIEM system 16 in this case is tasked with providing security for the IT infrastructure 14, e.g., by identifying potential attacks or issues and generating alerts. IT infrastructure 14 may include any number of services 22, such as a Virtual App and Desktop (VAD) service, a content collaboration service, other services, etc., which are subject to attack. Such a VAD service is commercially available from Citrix Systems of Fort Lauderdale, Fla. in the United States enables secure delivery of high performance apps and desktops to remote devices. A content collaboration service, which is also available from Citrix Systems enables users to share, sync, and secure content stored, e.g., on a cloud or on-premises storage. In one aspect, the services 22 expose resources that can be attacked by “legitimate users,” i.e., users that have been granted access rights and permissions to at least some of the provided services 22.

In one embodiment, STA 10 includes an initialization system 18 and a policy learning system 20. In operation, STA 10 implements automated test sessions that include user-behavior based security testing using reinforcement learning. In one example, reinforcement learning utilizes a Q-learning model. In a test session, STA 10 takes actions that a legitimate user could undertake in the target environment 12, such as e.g., downloading/uploading files using content collaboration service, deleting filings, emailing large amounts of data, etc. Each action undertaken by STA 10 alters the state of the IT infrastructure 14, which in turn is continuously scanned by the SIEM system 16 for security incidents. Results of the SIEM system 16 may be loaded to an alert data store 24, which can be accessed by STA 10. In one illustrative embodiment, the results of the continuous SIEM system scanning are binary, i.e., either an attack has been detected (producing a respective alert addressed to the environment administrator) or no attack has been detected. In other cases, the results could be non-binary, e.g., a sliding scale of alerts. Regardless, the continuous response of the SIEM system 16 effectively governs a reward system that is fed back to the policy learning system 20 in STA 10, each time STA 10 undertakes an action. In one approach, STA 10 receives a positive reward each time an action (i.e., a potential attack) does not yield a SIEM system alert and a negative reward when the action results in an alert. This action-reward feedback loop enables STA 10 to learn strategies to uncover attacks that are not detected by the SIEM system 16. Such vulnerabilities can be then reported and/or addressed.

To set up a test process, initialization system 18 is initialized with metadata that dictates how to undertake actions within IT infrastructure 14. Metadata may for example be maintained in STA store 23 and include:

(1) Information on how to access an endpoint in the IT infrastructure to undertake an action, e.g., a target uniform resource identifier (URI);

(2) Credentials and roles required to authenticate/authorize actions for a service 22 within the environment 12;

(3) A set of test scenarios to test against (e.g., in a content collaboration service, scenarios may include: Mass deletion of files, Mass Downloading/Exfiltration, etc. In one embodiment, the implementation of the distinct scenario to test against could be already part of the implementation of the STA 10 and these metadata could act as an index to a map for the test scenario to run. Each test scenario may include associated stored code or logic to perform the action, e.g., start action;

find file of size <file_size>;

if found, delete the file;

. . .

end action.

In other embodiments, the associated logic to perform the action could be explicitly encoded in the stored metadata, i.e., as a set of “command lines,” e.g., where the protocol to perform an action is uniform (e.g., REST, which stands for REpresentational State Transfer and is an architectural style for providing standards between computer systems on the web);

(4) A per test scenario including a goal to be achieved (referred to herein as a “test scenario goal”). For instance, the test scenario may include deleting data from a shared drive, and the test scenario goal could be to delete 1 Gbyte of data, i.e., the amount STA 10 seeks to delete without triggering a security alert;

(5) A set of reward parameters specific to the test scenario. For instance, in the case of the test scenario being the deletion of 1 Gbyte from a shared drive, the set of rewards may include: a reward received by deleting some portion of the that amount (e.g., the reward may be proportional to percent deleted), a reward received when deciding to not take any delete action, and a (relatively high) reward when attaining the test scenario goal;

(6) Optionally, additional attributes that form boundary conditions/attributes of the test case. For instance, in the case of mass downloading of data, the test scenario may confine the case to a set of target directories or filename regular expressions.

(7) If available, a stored policy (from STA store 23) of action-reward states that the agent may have learned in previously concluded test sessions.

In one illustrative embodiment, the test scenario is implemented with a reinforcement learning model such as a Q-learning model, which provides an environment model and Q-learning state, as well as rewards and actions to the problem at hand. Generally, the model is retrained whenever a new test scenario is introduced or the test scenario changes.

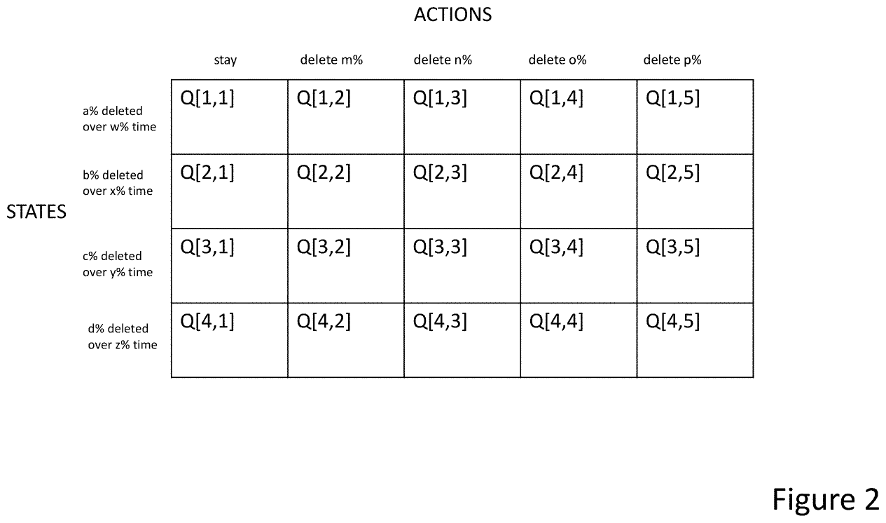

FIG. 2 shows one example of a Q-learning model in which a test scenario involves excessive content deletion with a test scenario goal T, where T is an 8-byte integer representing the target deletion size within a specific time window W, an initial state-action table is provided represented by a two dimensional matrix Q, where number of rows K equals to the number of possible states and number of columns C equals to the number of possible actions. A state S[i] may for example reflect “t % of T Kbytes that have been deleted after w % of W time has passed,” where the bin sizes for t and w can be chosen according to available memory resources and controls the number of rows.

In this model, the number of columns equals the number of actions that STA 10 can take. In the test scenario, STA 10 may either choose to stay in the same state or choose to delete up to j % of T Kbytes. Depending on memory constraints set by a given embodiment, the number of transitions may be limited to, e.g., deleting 1 MB in 1 KB chunks from a state perspective to keep the memory footprint of the Q matrix within bounds. In other embodiments, where accuracy/speed of convergence is preferred (over memory investment), the number of columns may be set to higher numbers.

Q[i,j] is the reward to be received when STA 10 is in state-i and decides to take the action specified by column-j. Equivalently and in the context of the problem at hand, this translates to the STA 10 having deleted t % of T Kbytes after w % of W time has passed, and taking the action to delete another j % Kbytes. The matrix Q can be initialized with all 0 integer values for Q[i,j], which is thereafter updated in each step during the learning phase implemented by policy learning system 20.

Additionally, and particularly to the illustrative embodiment of the content deletion test scenario, the STA 10 may also build an inverted index of file sizes (in Kbytes) to full file paths (in a target shared drive), e.g., in the form of a hash map, with the key being the file size and value being a set of full file paths. This allows the STA 10 to constrain next actions to feasible next states. For instance, if the STA 10 evaluates an action to delete 2 Kbytes, but there is no file of the such size, there is no feasible next action. Note that in alternative embodiment, this decision can be also based on combinations of remaining file sizes to be deleted, whose summation of sizes adds up to the action target (e.g., delete two 1 Kbyte files to take an action of deleting 2 Kbytes in total). This also allows the STA 10 to set the desired values in actions it undertakes by calling respective endpoints. In the embodiment of the content deletion test scenario, the STA 10 can use the inverted index to pick the full path(s) of the file (or files) to delete.

After having been initialized, policy learning system 20 (FIG. 1) implements the policy learning phase. The objective of this phase is for the STA 10 to learn (and store) a policy to interact with the environment 12 under test to attain the test scenario goal.

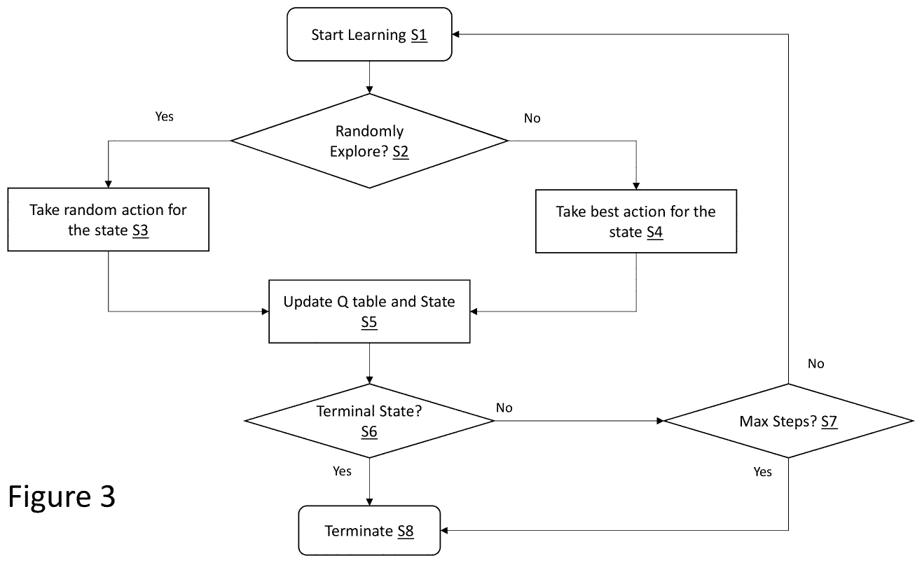

FIG. 3 depicts a flow chart depicting illustrative logic for the policy learning system 20. In this approach, the learning starts at S1 and at S2 the STA 10 uses an epsilon greedy strategy to decide whether as a next action it will randomly explore the IT infrastructure 14 at S3 or exploit previous learning at S4 and take the best action. In the first case S3, the STA 10 will choose a random action while in the latter case S4 STA 10 will use the action with the highest value in the Q matrix for the current state. The frequency that the exploration path will be chosen is controlled by ε, such that 0<ε<1 and whose value is reduced after a certain number of iterations. Intuitively, this allows the STA 10 to randomly explore more in the beginning of the training (S3) when it does not know anything about the environment 12, and exploit the latter (S4) when it has acquired more knowledge. In the illustrative test scenario of file deletion from a shared drive, this can also entail filtering the set of feasible actions by look ups to the inverted file size index.

Once a decision at S2 is determined and an action is decided, the STA 10 undertakes the action by making a respective call to the environment 12. Illustrative calls between the STA 10 and the IT infrastructure may e.g., include: the use of a Virtual Apps and Desktop (VAD) service Software Development Kit (SDK) that interfaces with a storefront application programming interface (API), the use of a browser, a specialized SDK that interfaces with a service API, etc. In the test scenario example of file deletion from a shared drive, this corresponds to making a deletion call to the shared drive, e.g., provided by a content collaboration service, with the target file paths specified in the payload. Once an action has been undertaken, the STA 10 starts polling the alert data store 24 for alert updates. In case an alert is produced, a predefined negative reward is incurred for that state-action combination and the Q[i,j] value in the Q matrix is updated accordingly at S5. Note that the communication of the alerts from the SIEM system 16 can be done in any manner. For instance, alternatively to polling, the STA 10 could start listening to an asynchronous message queue for alerts. In an alternative embodiment and to decouple the convergence speed of the STA 10 from the decision latency of the SIEM system 16, the STA 10 may proceed with opportunistic positive rewards and then decide to backtrack, in case an alert is received.

In one embodiment, the Q matrix is updated using the following formula:

$${Q}^{new} ( s , a ) = Q ( s , a ) + α ( R ( s , a ) + γ {max}_{a} Q ( {s}^{′} , a ) - Q ( s , a ) )$$

where α the learning rate with 0<α≤1, R(s,a) the reward received after completing action a at the state s, s′ is the next candidate state, and γ with 0≤γ≤1 the discount factor.

At S6, a determination is made whether the process is in a terminal state, e.g., an alert is generated or the goal is reached. If an alert is generated at S6 (indicating that SEIM system 16 detected the attack), STA 10 can terminate the process at S8 and, e.g., restart from scratch (from an initial Q-table) with a new randomized set of hyper-parameters, or even continue until the goal is achieved. If an alert is not generated at S6, a check is made at S7 to see if a maximum number of steps (i.e., actions taken) has been reached. If yes, the process terminates at S8. If no, the process repeats back to S1.

Once the STA 10 achieves the goal, the resulting learned Q matrix is stored as a learned policy in STA store 23 and a new “episode” (i.e., iteration) is started, whereby the Q matrix starting state is the already learned Q matrix.

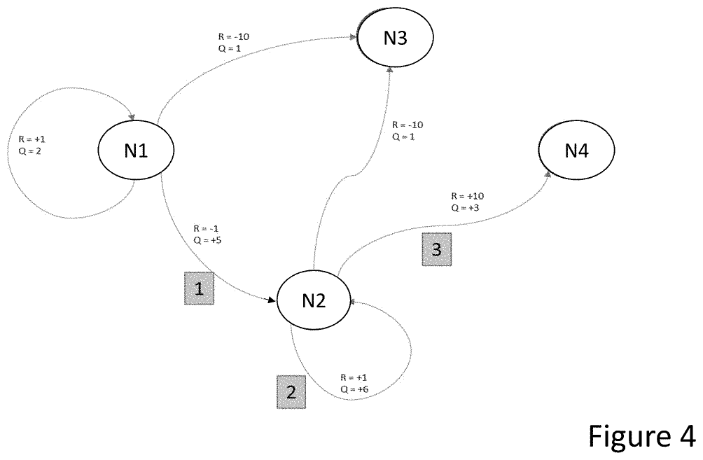

Error! Reference source not found. depicts a graph showing an example execution that demonstrates how a trained STA 10 would use the learned Q values, which maximize the sum of rewards to decide its actions in each state. States (N1, N2, . . . ) are depicted as nodes and actions as edges. Let N1 be the initial state and N3, N4 terminal states. The actions chosen are shown as paths 1, 2 and 3. It can be seen that in state N1, the STA 10 chooses an action that contains a relatively small immediate reward, R=−1, which might correspond to deleting a small number of files. However, because of the risk triggering an alert is highest among the choices, its quality Q=5, promising the highest overall reward. The same happens when in N2, where STA 10 decides to stay idle before proceeding to delete more files and completing its goal. Accordingly, R refers to the immediate reward (and is given as part of the design of STA 10) while Q refers to the value of the (state, action) with respect to the final goal and is learned by the agent during the policy learning phase. Q may be initialized randomly or initialized using certain initialization techniques, depending on the nature of the problem. In FIG. 4, the immediate reward R is a function of the deleted files size and the risk of triggering an alert.

The resulting policies learned by STA 10, which expose vulnerabilities in an environment 12, may be utilized for any purpose. In one embodiment, policies can be used to recommend rules to administrators. For example STA 10 could learn policy rules that are highly susceptible to be bypassed by given risk indicators and thus merit administrator alerting for incident review.

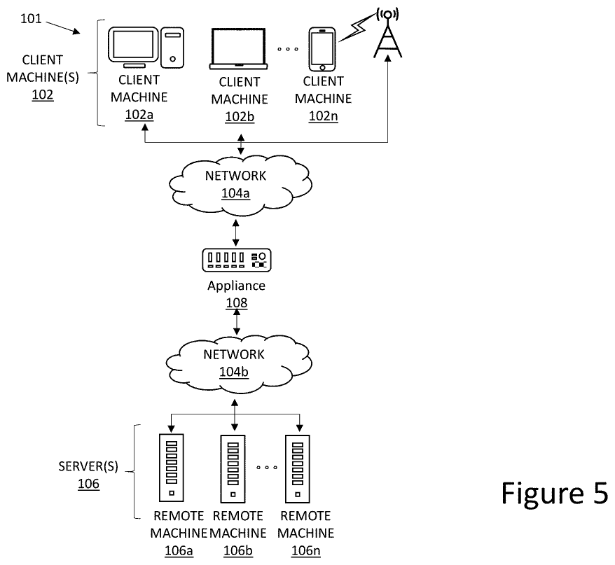

Referring to FIG. 5, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

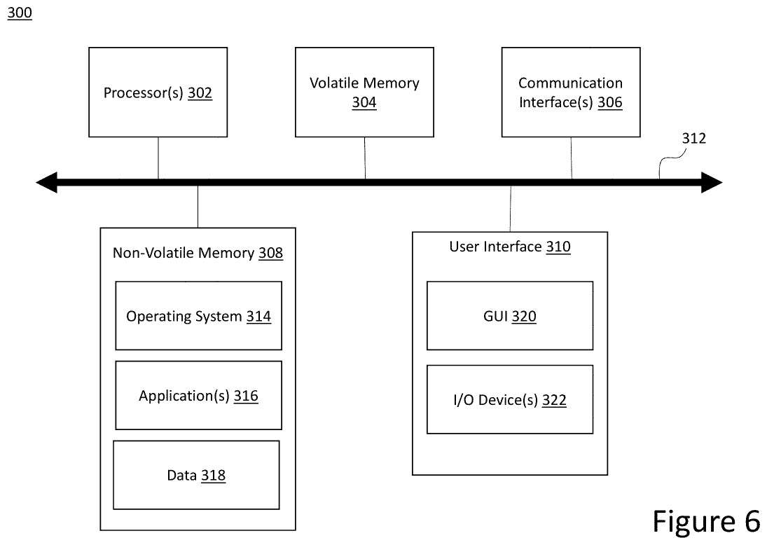

Elements of the described solution may be embodied in a computing system, such as that shown in FIG. 6 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 as shown in FIG. 6 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

1. A method for identifying vulnerabilities in a security information and event management (SIEM) system, comprising:
initializing a security testing agent (STA) with a test scenario goal and a reinforcement learning model, wherein the model defines a set of states indicative of progress towards the goal, a set of actions that can be taken by a legitimate user within a target environment, and a set of reward values associated with taking a specified action in a specified state; and
learning a policy to achieve the goal within the target environment, wherein the learning includes a process that:
selects and takes a target action from the set of actions for a current state;
monitors for an alert triggered in response to the target action being taken within the target environment;
receives a reward value associated with the target action and current state;
calculates and saves an updated reward value in the model; and
in response to the process not being terminated, repeats the process for a next state.

2. The method of claim 1, wherein, in response to the goal being achieved, outputting a saved model and policy, wherein the policy includes the actions taken to achieve the goal.

3. The method of claim 2, further comprising learning a new policy using the saved model.

4. The method of claim 1, wherein the process restarts in response to detection of the alert.

5. The method of claim 1, wherein the actions are selected from a group consisting of: deleting files, downloading content, accessing content, data exfiltration, unauthorized use of an information technology (IT) service, unauthorized use of data, and malicious acts targeting availability or reliability of an IT service.

6. The method of claim 1, wherein the target action is selected by either making a random selection or selecting the action having a highest reward value.

7. The method of claim 6, wherein the target action is further selected based on a feasibility of taking an available action within the target environment.

8. The method of claim 1, wherein the reinforcement learning model includes q-learning model implemented as a Q matrix with the set of states defined along a first axis and the set of actions defined along a second axis, wherein each entry in the Q matrix includes an associated reward value.

9. The method of claim 7, wherein the updated reward value is updated in the Q matrix according to the formula:
$${Q}^{new} ( s , a ) = Q ( s , a ) + α ( R ( s , a ) + γ {max}_{a} Q ( {s}^{′} , a ) - Q ( s , a ) )$$
where α is a learning rate with 0<α≤1,
R(s,a) is a reward received after completing the target action a at the current state s,
s′ is the next candidate state,
and γ is a discount factor with 0≤γ≤1.

10. The method of claim 1, wherein initialization further includes defining a set of procedures for accessing an endpoint within the target environment to take actions.

11. A system, comprising:
a memory; and
a processor coupled to the memory and configured to identify vulnerabilities associated with user actions in a security information and event management (SIEM) system, wherein identifying vulnerabilities includes:
initializing a security testing agent (STA) with a test scenario goal and a reinforcement learning model, wherein the model defines a set of states indicative of progress towards the goal, a set of actions that can be taken by a legitimate user within a target environment, and a set of reward values associated with taking a specified action in a specified state; and
learning a policy to achieve the goal within the target environment, wherein the learning includes a process that:
selects and takes a target action from the set of actions for a current state;
monitors for an alert triggered in response to the target action being taken within the target environment;
receives a reward value associated with the target action and current state;
calculates and saves an updated reward value in the model; and
in response to the process not being terminated, repeats the process for a next state.

12. The system of claim 11, wherein, in response to the goal being achieved, outputting a saved model and policy, wherein the policy includes the actions taken to achieve the goal.

13. The system of claim 12, further comprising learning a new policy using the saved model.

14. The system of claim 11, wherein the process restarts in response to detection of the alert.

15. The system of claim 11, wherein the actions are selected from a group consisting of: deleting files, downloading content, accessing content, data exfiltration, unauthorized use of an information technology service, unauthorized use of data, and malicious acts targeting availability or reliability of an IT service.

16. The system of claim 11, wherein the target action is selected by either making a random selection or selecting the action having a highest reward value.

17. The system of claim 16, wherein the target action is further selected based on a feasibility of taking an available action within the target environment.

18. The system of claim 11, wherein the reinforcement learning model includes q-learning model implemented as a Q matrix with the set of states defined along a first axis and the set of actions defined along a second axis, wherein each entry in the Q matrix includes an associated reward value.

19. The system of claim 17, wherein the updated reward value is updated in the Q matrix according to the formula:
$${Q}^{new} ( s , a ) = Q ( s , a ) + α ( R ( s , a ) + γ {max}_{a} Q ( {s}^{′} , a ) - Q ( s , a ) )$$
where α is a learning rate with 0<α≤1,
R(s,a) is a reward received after completing the target action a at the current state s,
s′ is the next candidate state,
and γ is a discount factor with 0≤γ≤1.

20. The system of claim 11, wherein initialization further includes defining a set of procedures for accessing an endpoint within the target environment to take actions.
